(19) United States
(12) Patent Application Publication
(10) Pub. No.: US 2005/0276204 A1
(43) Pub. Date: Dec. 15, 2005

(54) Objective lens drive unit in an optical head

(75) Inventors: Masayuki Fujita, Tokyo (JP); Taku Tsuboi, Tokyo (JP)

Correspondence Address: Paul-J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/147,099

(22) Filed: Jun. 7, 2005

(30) Foreign Application Priority Data
Jun. 11, 2004 (JP) 2004-174369

(51) Int. Cl. G11B 7/00; G11B 7/135

(52) U.S. Cl. 369/112.02; 369/44.14; 369/44.11

(57) ABSTRACT

An objective lens drive unit in an optical head includes a lens holder mounting thereon an objective lens, a sheet coil unit including a focusing coil and a tracking coil, and a pair of liquid crystal devices (LCDs) correcting a coma aberration and astigmatism of the optical beam from the objective lens, and an LCD drive circuit for driving the LCDs. The lens holder is cantilevered by a plurality of suspension wires, which deliver therethrough coil drive signals and LCD drive signals superposed on the coil drive signals.

### BACKGROUND OF THE INVENTION

(a) Field of the Invention

The present invention relates to an objective lens drive unit in an optical head which is capable of correcting an aberration of the optical beam incident onto the objective lens.

(b) Description of the Related Art

Recently, optical disk drives are widely used, in a household optical disk recorder and in a computer system as an auxiliary storage device, for recording data in an optical disk and reproducing data therefrom. The optical disk drives are required to have a higher-speed and higher-density recording/reproducing capability for handling larger-capacity data. The higher-density recording in an optical disk drive requires reduction of the size of an optical beam spot, which in turn requires a shorter wavelength of the laser light as well as a larger numerical aperture (NA) of the objective lens for irradiating the optical disk with the optical beam spot.

More recently, along with the wide use of optical disks, the number of the optical disks on the market is remarkably increased, and some of the inferior optical disks have a thickness above the standard thereof. In the inferior optical disk having a thickness above the standard, it is known that the optical beam spot formed on the optical disk causes a spherical aberration therein to thereby degrade the recording/reproducing characteristics of the optical beam spot. In addition, if the optical disk has a warp thereon, the slope of the disk surface caused by the warp generates an inclination of the optical axis, to thereby generate a coma aberration, which also degrades the recording/reproducing characteristics of the optical beam spot.

Along with the increase of the storage capacity of the optical disk, aberrations such as the spherical aberration, astigmatism and coma aberration caused in the optical beam spot cannot be neglected in view of degradation of the recording/reproducing characteristics. Since the quality of the optical beam spot is an increasingly important factor in an optical disk drive used for an optical disk having a large storage capacity, the optical disk drive should have a function for reducing the variety of aberrations to suppress the degradation of recording/reproducing characteristics.

Patent Publication JP-A-2000-131603 describes an optical disk drive having a function for reducing an aberration of an optical beam spot. FIG. 10 shows the optical disk drive 200 described therein. An objective lens 220 is driven in the focusing direction as well as the tracking direction by a two-axis actuator 216, to irradiate an optical beam spot onto the recording surface of an optical disk 211. Between the objective lens 220 and a laser light source not shown, there is provided a single-axis actuator 221, which drives an optical element 201 in the direction of the light beam. The optical element 201 has a function of correcting the spherical aberration of the laser beam.

It is noted that the optical head 200 of FIG. 10 has a drawback that it is difficult to reduce the dimensions thereof due to insertion of the single-axis actuator 221 within the optical path of the optical head.

Patent Publication JP-A-2001-266394 describes another optical head having smaller dimensions and capable of correcting an aberration. FIG. 11 shows the objective lens drive unit in the optical head described in this publication, whereas FIG. 12 shows the circuit diagram thereof. The objective lens drive unit 300 includes an objective lens 301 mounted on a lens holder 302, which receives therein an LCD (liquid crystal device) 307 on the bottom side of the objective lens 301. The LCD 307 functions as a light valve or light control means, and corrects the optical beam incident onto the objective lens 302, to reduce the aberrations. In this technique, the LCD 307 is driven together with the lens holder 302 in unison, whereby the optical axis of the objective lens 301 is not deviated from the optical axis of the LCD 307. Thus, if the objective lens 301 is moved in the tracking direction, the performance for correcting the aberrations is not degraded.

The lens holder 302 is cantilevered by four supporting wires 303a to 303d each having an electric conductivity and fixed onto a wire holder 311 at one end. The wire holder 311 mounts thereon a tilt sensor 313. The lens holder 302 is wound by a focusing coil 304 and a tracking coil 305, which receive a focusing control signal from a focusing control circuit 316 and a tracking control signal from a tracking control circuit 317, respectively, through the supporting wires 303 to 303d. The focusing control circuit 316 and the tracking control circuit 317 are disposed outside the lens holder 302, which configures a movable part driven in the focusing direction as well as the tracking direction.

The LCD 307 includes an LC (liquid crystal) layer and a pair of glass substrates sandwiching therebetween the LC layer. One of the glass substrates in the LCD 307 mounts thereon, as shown in FIG. 12, a plurality of electrodes 307a to 307e which are patterned for correcting the coma aberration, whereas the other of the glass substrate mounts thereon a counter electrode 307f. The LCD 307 receives an LCD drive signal from an LCD drive circuit 318, which controls the voltages applied between electrodes 307a to 307e and electrodes 307f. In JP-A-2001-266384, it is described that the LCD drive signal is superposed on the focusing and tracking control signals, whereby the four supporting wires 303a to 303d drive the focusing coil 304, tracking coil 305 and LCD 307.

The technique described in JP-A-2001-266384 is such that the voltages applied to electrodes 303a to 303e are ramp voltages generated by a resistor string including serial resistors 307h to 307k. The ramp voltages thus generated can achieve only a limited correction function for correcting the aberration because the profile of the ramp voltages generated by the resistor string is not an optimum profile. That is, the technique cannot correct and reduce the aberration of the optical beam spot to a desired level.

In addition, the combination of patterned electrodes 307a to 307e can only correct one of the aberrations, such as the coma aberration as described above, and thus cannot correct others of the aberrations such as the spherical aberration and astigmatism. That is, the technique cannot correct a plurality of aberrations of the optical beam spot.

If a plurality of LCDs each for correcting a corresponding one of aberrations are disposed in the lens holder 302, then a plurality of aberrations can be corrected by the LCDs. In this case, however, each LCD necessitates transmission of an LCD drive signal, thereby increasing the number of supporting wires 302 for transmitting the LCD drive signals, which is undesirable.

In view of the above problems encountered in the conventional techniques, it is an object of the present invention to provide an objective lens drive unit for use in an optical head, which is capable of finely correcting an aberration of the optical beam spot to a desired level.

It is another object of the present invention to provide an objective lens drive unit for use in an optical head, which is capable of correcting a plurality of aberrations while suppressing the increase in the number of support members for supporting the movable part of the optical head.

It is another object of the present invention to provide an optical head including such an objective lens drive unit.

The present invention provides an objective lens drive unit including: a stationary part; a movable part mounting thereon an objective lens focusing a light beam onto an optical disk and a lens-drive coil unit driving the objective lens with respect to the stationary part in at least one specified direction; and at least one support member supporting the movable part while allowing the movable part to move with respect to the stationary part, the movable part including at least one liquid crystal device (LCD) correcting an aberration of an optical beam from the objective lens and an LCD drive circuit driving the LCD.

In accordance with the objective lens drive unit of the present invention, the LCD drive circuit disposed on the movable part allows the LCD to reduce the aberration to a desired level by finely adjusting the LCD drive signal.

It is preferable that the at least one LCD include a plurality of LCDs controlled by the LCD drive circuit independently of one another. In this configuration, the LCDs correct different aberrations of the optical beam spot to improve the recording/reproducing characteristics thereof, while suppressing the increase of the number of wires for delivering LCD control signals.

The above and other objects, features and advantages of the present invention will be more apparent from the following description, referring to the accompanying drawings.

### BRIEF DESCRIPTION OF THE DRAWINGS

FIG. 1 is a perspective view of an optical head including an objective lens drive unit according to a first embodiment of the present invention.

FIG. 2 is an exploded perspective view of the optical head of FIG. 1 as viewed from the bottom side thereof.

FIG. 3 is a perspective view of a part of the optical head of FIG. 2 as viewed from another direction.

FIG. 4 is an exploded perspective view of the LCD shown in FIG. 3.

FIG. 5 is a circuit diagram of the objective lens drive unit shown in FIG. 1.

FIGS. 6A and 6B are graphs showing relationships between the pupil diameter and an aberration when the aberration is corrected by the LCD in the first embodiment.

FIG. 7 is circuit diagram of an objective lens drive unit according to a second embodiment of the present invention.

FIG. 8 is a circuit diagram of an objective lens drive unit according to a modification from the second embodiment.

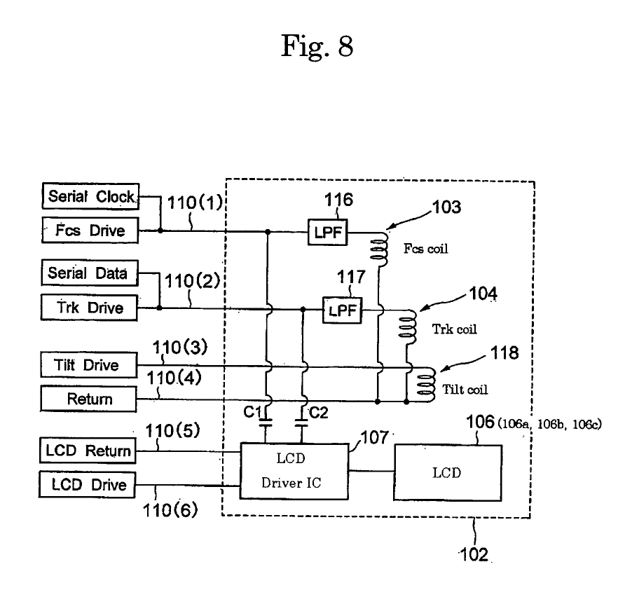

FIG. 9 is a circuit diagram of an objective lens drive unit according to a modification from the first embodiment.

FIG. 10 is a sectional view of a conventional optical head described in a publication.

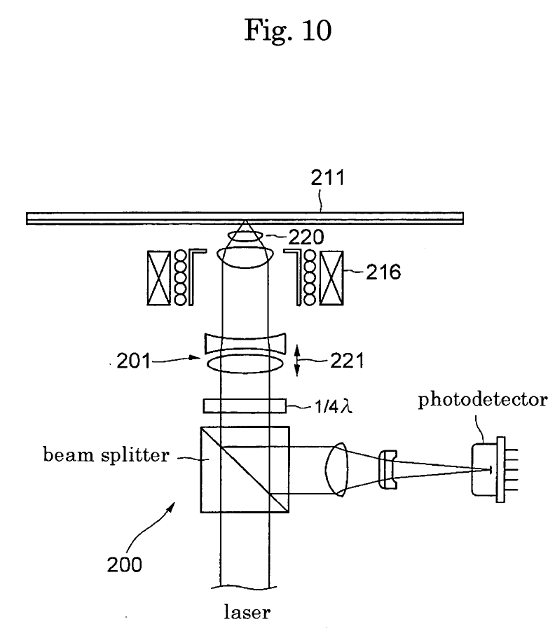

FIG. 11 is a sectional view of another conventional optical head described in another publication.

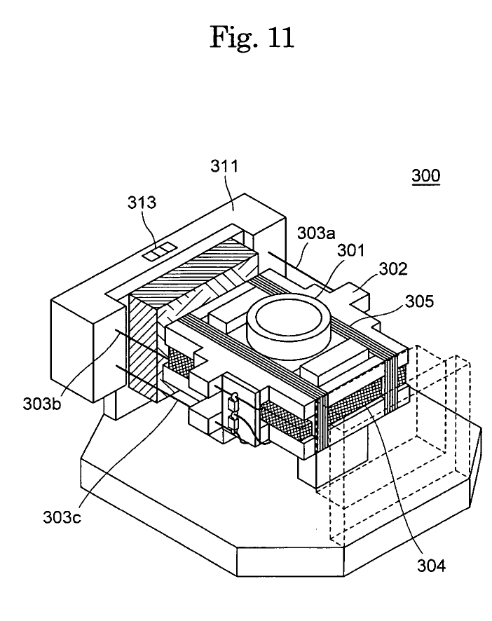

FIG. 12 is a circuit diagram of the objective lens drive unit in the optical head of FIG. 11.

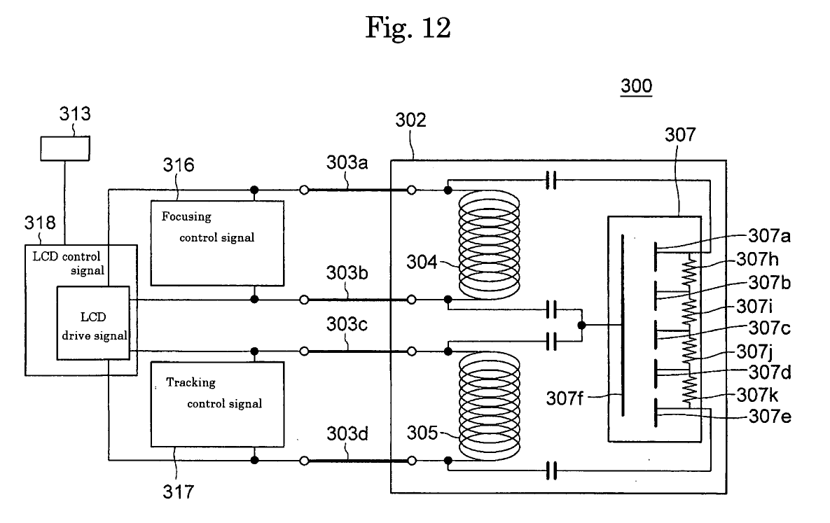

### PREFERRED EMBODIMENT OF THE INVENTION

Now, the present invention is more specifically described with reference to accompanying drawings, wherein similar constituent elements are designated by similar reference numerals.

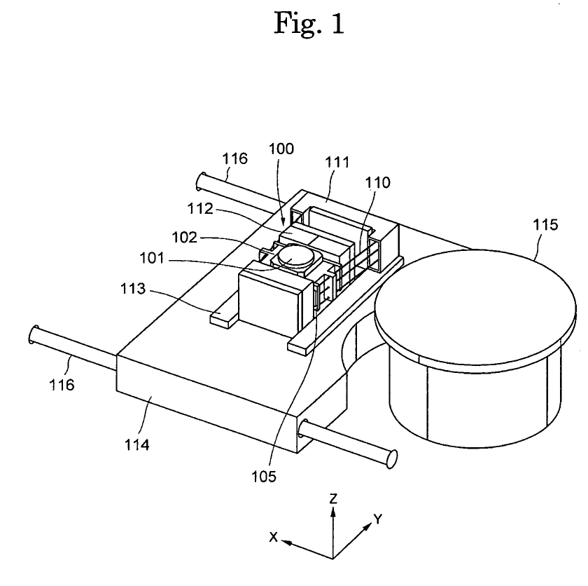

Referring to FIG. 1, an optical head, generally designated by numeral 100, includes an objective lens 101, a lens holder 102, a pair of magnet members 112, six supporting members 110, a stationary block 111 and a yoke 113. The optical head 100 is mounted on and fixed to a carriage 114, which is moved along a pair of guide rails 116 in a radial direction which is normal to recording tracks of an optical disk (not shown) rotated by a spindle motor 115.

The objective lens 101 is mounted on a lens holder 102, and condenses the light emitted from a light source not shown, to form an optical beam spot on the recording surface of an optical disk. The yoke 113 is fixed onto the carriage 114, and is attached with the magnet members 112 and stationary block 111. The yoke 113 has a function for improving the profile of the magnetic field generated by the magnet members 112.

The supporting members 110 are configured as suspension wires having elasticity. One end of the supporting member 110 is fixed onto the lens holder 102, and the other end of the supporting member 110 is fixed onto the stationary block 111. The lens holder 102 configures a movable part receiving therein a plurality of members (movable members), and is elastically cantilevered by the supporting members 110 against the stationary block 111. Each supporting member 110 has an electric conductivity, and electrically connects together the movable members in the lens holder 102 and stationary members outside the lens holder 102.

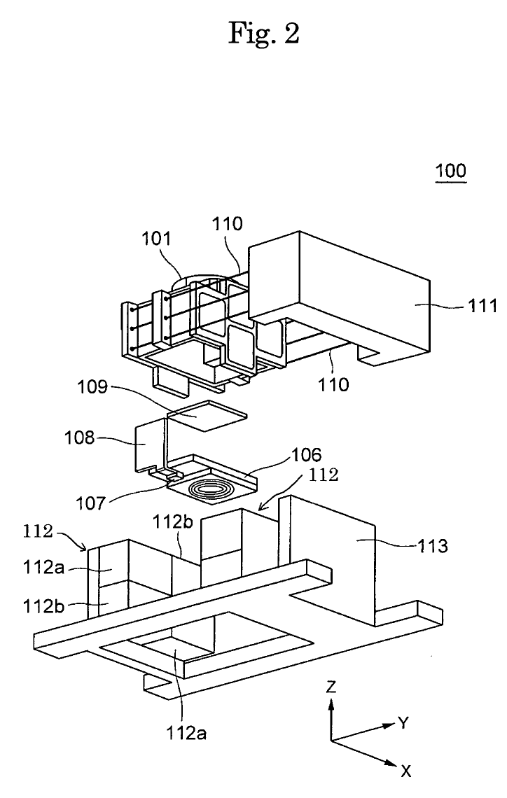

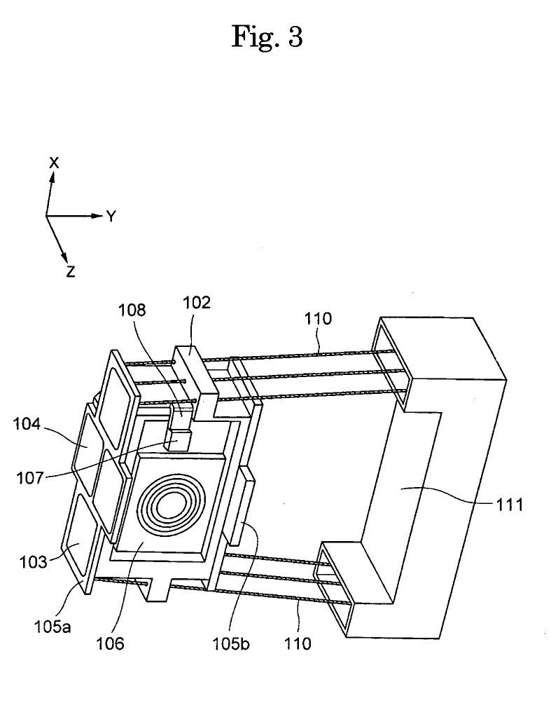

FIG. 2 shows the optical head of FIG. 1 in an exploded perspective view as viewed from the bottom side thereof in one direction, whereas FIG. 3 shows part of the optical head as viewed from the bottom side thereof in another direction. Both the end surfaces of the lens holder 102 as viewed in Y-direction are attached with sheet coil units 105a and 105b each including focusing coil and a tracking coil. The sheet coil units 105a and 105b oppose respective magnet members 112 in an operable state of the optical head.

Each magnet member 112 has four divided sections 112a and 112b, wherein each two adjacent divided sections 112a and 112b have opposite poles on the surfaces opposing the sheet coil unit 105a or 105b. More specifically, in FIG. 2 for example, a divided section 112a of the magnet member 112 has an N-pole on the surface opposing the sheet coil unit 105a or 105b, whereas a divided section 112b has an S-pole on the surface opposing the sheet coil unit 105a or 105b.

The focusing coil 103 and tracking coil 104 in each sheet coil unit 105a or 105b receive a focusing control signal and a tracking control signal, respectively, to generate magnetic fields based on the received control signals. In the optical head 100, the magnetic fields generated by the magnetic members 112a and 112b and the magnetic fields generated by the focusing coils 103 and tracking coils 104 produce a driving force, which moves the lens holder 102 in the focusing direction as well as the tracking direction. This configuration of the optical head 100 allows the lens holder 102 to follow vertical displacement and horizontal (eccentric) displacement of the surface portion of the optical disk above which the optical head stays.

As shown in FIG. 2, a wavelength (λ/4) plate 109 and an LCD pair 106 (106a, 106b) are attached onto the bottom side of the objective lens 101. Each LCD 106 includes an LC layer and a pair of glass substrates sandwiching therebetween the LC layer. A driver IC (LCD driver IC) 107 receives the power source and LCD control signals via a connecting board 108 such as configured as a flexible printed circuit (FPC) board. The driver IC 107 supplies an LCD drive signal having a rectangular wave, for example, to the LCD pair 106 to drive the same. In the optical head 100, these driver IC and connecting board 108 are received in the lens holder 102 together with the LCD pair 106.

On one of the glass substrates of each LCD 106, there are provided a plurality of transparent electrodes patterned to a desired configuration, whereby the each LCD 106 is divided into a plurality of segments. Each LCD 106 has a dedicated pattern of the transparent electrodes. The LCD 106 controls the refractive indexes of the segments to thereby correct an aberration of the optical beam spot irradiated through the objective lens onto the recording surface of the optical disk. The driver IC 107 has a plurality of control channels, which can control the segments independently of one another in each of the LCDs 106.

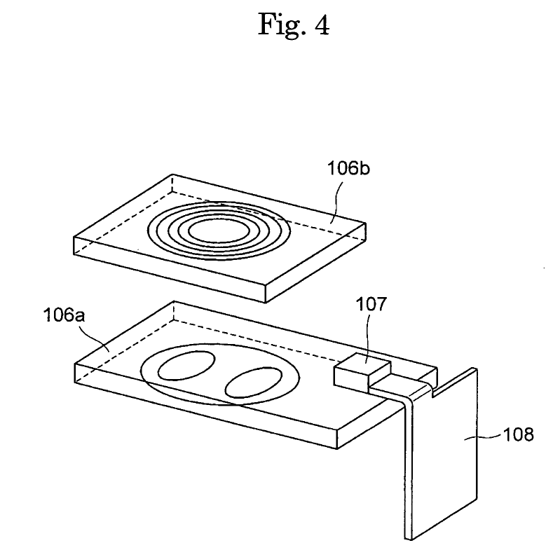

FIG. 4 shows the LCD pair 106 in an exploded perspective view. The LCD pair 106 includes first and LCDs 106a and 106b each having a transparent electrode pattern for correcting a corresponding one of the plurality of aberrations. In this example, the first LCD 106a has a pattern of the transparent electrodes which corrects the coma aberration, whereas the second LCD 106b has a pattern of the transparent electrodes which corrects the astigmatism. Each LCD 106a or 106b functions as a light valve which controls transmission of light on an electrode-by-electrode basis. The driver IC 107 is mounted on the first LCD 106a of the LCD pair 106 by using a chip on glass (COG) technique. The LCD driver IC drives both the first and second LCDs 106a and 106b by using such potential profiles that finely correct the respective aberrations.

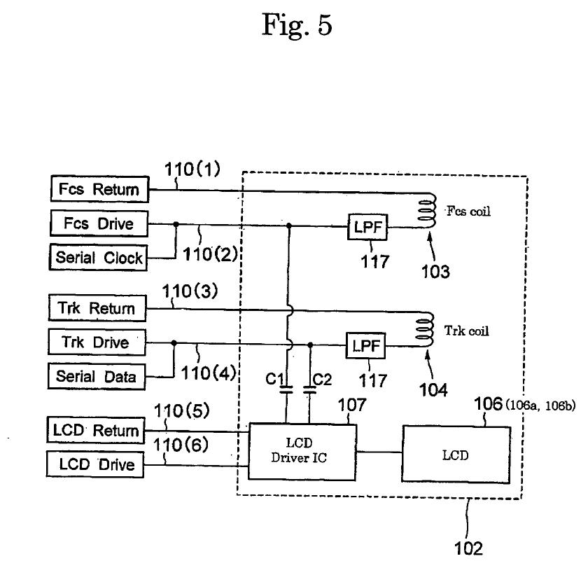

FIG. 5 shows electric connections for the focusing coil 103, tracking coil 104, driver IC 107 and LCDs 106 (106a, 106b) via the supporting members (wires) 110. All the signals including the focusing control signal for driving the focusing coil 103, the tracking control signal for driving the tracking coil 104, the serial control data for controlling the driver IC 107 and the serial clock signal for controlling reception of the serial control data are generated by the stationary members disposed outside the lens holder 102. These signals are delivered therefrom through the supporting wires 110(1) to 110(6) to the lens holder 102 which configures the movable part.

Four supporting wires 110(1) to 110(4) among the six supporting wires 110(1) to 110(6) that support the lens holder 102 are used to deliver focusing control signal, tracking control signal and LCD driver control data. The remaining two supporting wires 110(5) and 110(6) are used as power source lines for delivering power source to the driver IC 107.

More specifically, the serial control data delivered to the driver IC 107 is superposed on the tracking control signal, and delivered to the lens holder 102 through the supporting wire 110(4) which functions as a drive line for the tracking coil 104. The serial clock is superposed on the focusing control signal, and delivered to the lens holder through the supporting wire 110(2) which functions as a drive line for the focusing coil 103.

Each of the focusing control signal and tracking control signal has a lower signal frequency of around several hundreds of kHz or below, whereas each of the serial control data and the serial clock has a higher signal frequency of around 1 MHz or above. Thus, the superposed signals can be separated from one another by using a low-pass-filter (LPF) which passes a lower frequency of several hundreds of kHz or below or a high-pass-filter (HPF) which stops the lower frequency of several hundreds of kHz.

Each of the serial control data and serial clock should preferably have a rectangular waveform having a duty ratio of 50% or above. This prevents occurring of an offset due to superposition of the serial control signal or serial clock onto the focusing control signal etc.

In the present embodiment, the drive line 110(2) for the focusing coil 103 has a first branch in the lens holder 102 to be connected to the focusing coil 103 via an LPF 117, and a second branch in the lens holder 102 to be connected to the LCD driver IC 107 via a capacitor C1, or a HPF, and the connecting board 108 not shown in FIG. 5.

The LPF 117 passes only the focusing control signal from the superposed signals including the focusing control signal and the serial clock, delivering the focusing control signal to the focusing coil 103. The capacitor C1 only passes the serial clock from the superposed signals including the focusing control signal and the serial clock, delivering the serial clock to the LCD driver IC 107.

The drive line 110(4) for the tracking coil 104 has a first branch in the lens holder 102 to be connected to the tracking coil 104 via an LPF 117, and a second branch in the lens holder 102 to be connected to the LCD driver IC 107 via a capacitor C2, or a HPF, and the connecting board 108 not shown in FIG. 5.

The LPF 117 passes only the tracking control signal from the superposed signals including the tracking control signal and the serial control data, delivering the tracking control signal to the tracking coil 104. The capacitor C2 only passes the serial control data from the superposed signals including the tracking control signal and the serial control data, delivering the serial control data to the LCD driver IC 107.

The LCD driver IC 107 receives serial data, which controls the plurality of segments of both the LCDs 106a and 106b, from the supporting wire 110(4) based on the serial clock received via the supporting wire 110(2). The LCD driver IC 107 controls the voltages applied to the transparent electrodes formed on the glass substrate of each of the LCDs 106a and 106b. The control of the voltages applied to the transparent electrodes in the LCD 106a corrects the coma aberration of the optical beam spot, whereas the control of the voltages applied to the transparent electrodes in the LCD 106b corrects the astigmatism of the optical beam spots. Thus, the optical beam focused onto the recording surface of the optical disk is free from both the coma aberration and astigmatism.

In the present embodiment, the refractive indexes of the respective segments of each LCD are controlled to correct an aberration of the optical beam spot. By controlling the voltages applied to the segments of the LCD 106a or 106b independently of each other, the aberration can be corrected finely and thus reduced to a desired level. This improves the quality of the optical beam spot, thereby providing excellent recording/reproducing characteristics thereto.

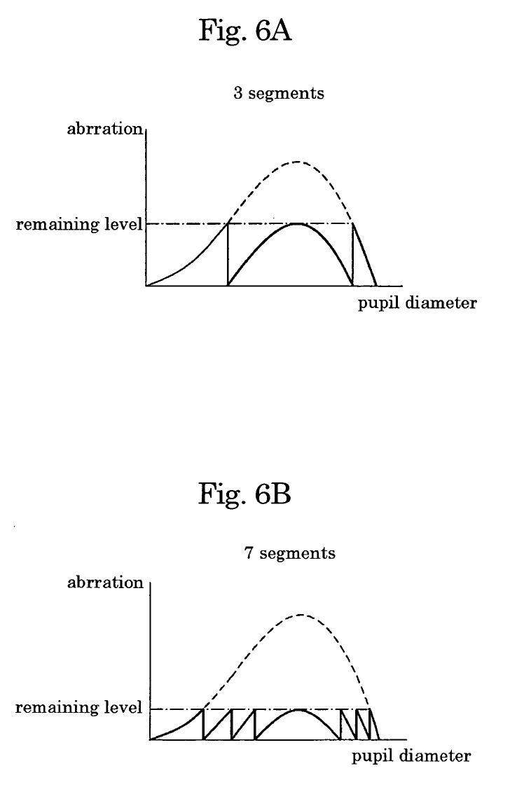

FIGS. 6A and 6B show graphs representing relationships between the pupil diameter and an aberration of the optical beam spot corrected by using the LCD 106a or 106b. FIG. 6A shows a case wherein the number of divided segments in the LCD is three, and FIG. 6B shows another case wherein the number of divided segments in the LCD is seven. In both the figures, the dotted line represents the aberration before correction, whereas the solid line represents the aberration after the correction by the LCD.

It is noted that the control of the voltages applied to the segments reduces the aberration as understood from both FIGS. 6A and 6B, and that a larger number of divided segments and thus a smaller divided area of the divided segments reduce the aberration after the correction so long as the pattern of the divided segments is appropriately selected, as understood from the comparison of FIG. 6B against FIG. 6A.

In general, a larger number of divided segments in the LCD 106 used in the optical head 100 increases the number of data to be supplied to the LCD 106 received in the lens holder 012. This generally requires a larger number of electric wires to be provided between the stationary block 111 and the lens holder 102. In the present embodiment, since the driver IC 107 receives the serial control data to be used for controlling the LCD 106, a larger number of the divided segments does not result in an increase of the number of wires for delivering the control data between the lens holder 102 and the stationary member 111.

In addition, since the serial control data and the serial clock used for receiving the serial control data are superposed on the tracking control signal and the focusing control signal, respectively, the number of the supporting wires is not increased by using the serial control data and the serial clock.

In the present embodiment, the LCDs 106 include the first LCD 106a disposed for correcting the coma aberration and the second LCD 106b disposed for correcting the astigmatism. The plurality of LCDs 106a and 106b provided in the lens holder 102 allow a plurality of aberrations to be corrected, to thereby improve the quality of the optical beam spot. The control of the LCDs by a single driver IC does not increase the number of supporting wires if the number of the LCDs provided is increased.

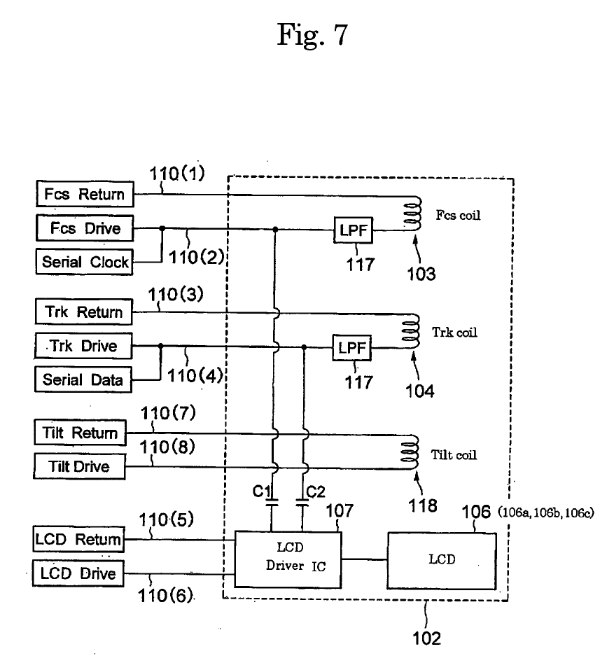

FIG. 7 shows a circuit diagram of an objective lens drive unit according to a second embodiment of the present invention. The objective lens drive unit of the present embodiment is similar to the first embodiment except that a radially tilting coil 118 is provided in the present embodiment. The addition of the radially tilting coil 118 increases the number of supporting wires 110 up to eight, wherein supporting wires 110(7) and 110(8) supply radial-tilt controlling signal to the radially tilting coil 118. Thus, the lens holder 102 is cantilevered by eight supporting wires 110(1) to 110(8) against the stationary block 111.

In the present embodiment, the lens holder 102 is driven or moved in the radial-tilt direction in addition to the focusing direction and tracking direction. The radial-tilt control of the lens holder 102 corrects the coma aberration of the optical beam spot. Thus, the lens holder 102 mounts thereon three LCDs 106 including an LCD (106c) for correcting the coma aberration, an LCD (106b) for correcting the astigmatism and an LCD (106a) for correcting the spherical aberration.

In the above embodiment, the return lines 110(1), 110(3) and 110(7) for the focusing coil 103, tracking coil 104 and radially tilting coils 118 are implemented by separate supporting wires. However, these return lines may be formed common. In such a case, the number of supporting wires can be reduced to six.

In the above embodiment, the serial clock and serial control data are superposed onto the focusing control signal and tracking control signal, respectively. However, the combination may be selected as desired. For example, if a radial-tilt coil 118 is provided in the lens holder 102, the serial clock and the serial control data may be superposed onto the tracking control signal and radial-tilt control signal, respectively.

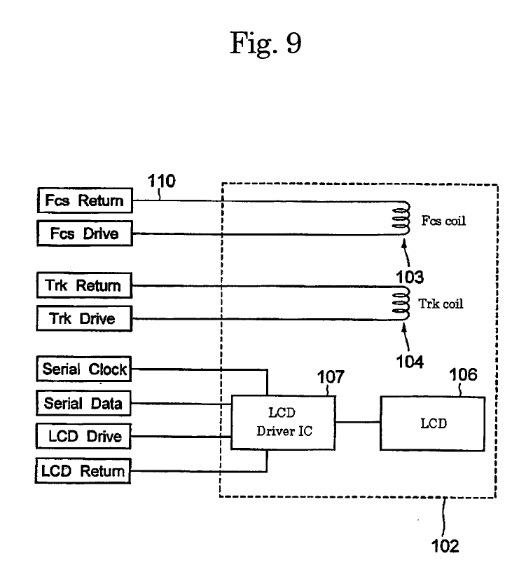

In an alternative, the serial clock and serial control data may be delivered directly to the driver IC 107, as shown in FIG. 9 which shows a modification from FIG. 5, without superposing these signals onto other signals.

In the above embodiment, the supporting members are implemented as suspension wires. However, the supporting members are not limited to this configuration and may have any configuration so long as the supporting members have a supporting function and an electric conductivity. For example, the supporting members 110 may be hinges such as made from leaf springs.

In the above embodiment, the driver IC 107 is mounted on the LCD 106 by using a COG technique: however, mounting of the driver IC 107 is not limited to this technique. For example, the driver IC 107 may be mounted on the connection board 108 or another member which is driven in unison with the lens holder 102. The connection board is not limited to a FPC. The focusing coil 103, tracking coil 104 and radially tilting coil 118 may be formed as wounded coils as well as the sheet coil unit.

If the optical disk drive is to drive compact disk (CD), digital versatile disk (DVD) and high definition DVD (HDDVD), the optical disk drive should have mechanisms to meet a variety of wavelengths and a variety of numerical apertures. In such a case, it is sufficient that the wavelength plate 109 shown in FIG. 2 be associated with an optical member having an aperture-limiting function, separately from the wavelength plate 109, on the bottom side of the objective lens 101. This configuration allows the optical disk drive to be adapted to a variety of types of optical disks. The LCD 106 and the wavelength plate 109 may be formed as a unitary body.

Since the above embodiments are described only for examples, the present invention is not limited to the above embodiments and various modifications or alterations can be easily made therefrom by those skilled in the art without departing from the scope of the present invention.

1. An objective lens drive unit comprising:
a stationary part;
a movable part mounting thereon an objective lens focusing a light beam onto an optical disk and a lens-drive coil unit driving said objective lens with respect to said stationary part in at least one specified direction; and
at least one support member supporting said movable part while allowing said movable part to move with respect to said stationary part,
said movable part including at least one liquid crystal device (LCD) correcting an aberration of an optical beam from said objective lens and an LCD drive circuit driving said LCD.

2. The objective lens drive unit according to claim 1, wherein said at least one support member include a plurality of elastic wires, and said LCD drive circuit receives control data through said elastic wires to control said LCD based on said control data.

3. The objective lens drive unit according to claim 2, wherein said control data is delivered as a serial data signal.

4. The objective lens drive unit according to claim 3, wherein said serial data signal is superposed on a lens drive signal driving said lens-drive coil unit.

5. The objective lens drive unit according to claim 1, wherein said LCD includes a plurality of segments controlled by said LCD drive circuit independently of one another.

6. The objective lens drive unit according to claim 1, wherein said LCD drive circuit is mounted on a glass substrate of said LCD.

7. The objective lens drive unit according to claim 1, wherein said at least one LCD include a plurality of LCDs controlled by said LCD drive circuit independently of one another.

8. The objective lens drive unit according to claim 7, wherein said lens-drive coil unit includes a focusing coil driving said objective lens in a direction of an optical axis thereof, and a tracking coil driving said objective lens in a direction normal to said optical axis, and wherein said plurality of LCDs include at least two of an LCD having a function of correcting a spherical aberration, an LCD having a function of correcting an astigmatism and an LCD having a function of correcting a coma aberration.

9. The objective lens drive unit according to claim 7, wherein said lens-drive coil unit includes a focusing coil driving said objective lens in a direction of an optical axis thereof, a tracking coil driving said objective lens in a direction normal to said optical axis, and a radially tilting coil driving said objective lens in a direction of radial-tilt, and wherein said plurality of LCDs include an LCD having a function of correcting a spherical aberration, an LCD having a function of correcting an astigmatism and an LCD having a function of correcting a coma aberration.

10. An optical head comprising the objective lens drive unit according to claim 1.

11. An objective lens drive unit comprising:
a stationary part;
a movable part mounting thereon means for focusing a light beam onto an optical disk and means for driving said objective lens with respect to said stationary part in at least one specified direction; and
means for supporting said movable part while allowing said movable part to move with respect to said stationary part,
said movable part including at least one light valve unit for correcting an aberration of an optical beam passed by said focusing means and a light valve drive circuit for driving said light valve unit.
